(19) United States
(12) Patent Application Publication
(10) Pub. No.: US 2026/0267454 A1
(43) Pub. Date: Sep. 10, 2026

(54) USER INTERFACE, TRANSPORTATION VEHICLE AND METHOD OF DESIGNING A GRAPHICAL USER INTERFACE BY A USER

(71) Applicant: VOLKSWAGEN AKTIENGESELLSCHAFT, Wolfsburg (DE)

(72) Inventors: Robert Jan WYSZKA, Hannover (DE); Eduardo Luiz VIEIRA, Berlin (DE); Franziska HOPPEN, Magdeburg (DE); Janine BRETZ, Braunschweig (DE)

(21) Appl. No.: 19/164,070

(22) PCT Filed: Feb. 15, 2024
(86) PCT No.: PCT/EP2024/053830

§ 371 Date: Sep. 10, 2025

(30) Foreign Application Priority Data
Mar. 14, 2023 (DE) 10 2023 202 302.4

(51) Int. Cl. G06F 3/0481; B60K 35/10; B60K 35/22; B60K 35/25; G06F 3/04847; G06F 3/16; G06T 13/00

(52) U.S. Cl. CPC G06F 3/0481; B60K 35/10; B60K 35/22; B60K 35/25; G06F 3/04847; G06T 13/00; B60K 2360/1468; G06F 3/167; G06T 2200/24; G06T 2210/21

(57) ABSTRACT

A user interface, a transportation vehicle and a method for outputting feedback to an occupant relating to a driving state of a transportation vehicle by a graphical user interface. The method includes displaying a virtually oscillatable oscillator on the user interface; determining a user input with respect to the oscillator and, in response, placing the oscillator in a target position on the graphical user interface; determining a signal representing an acceleration and/or a vibration of the transportation vehicle and, in response and according to the signal, bringing about an oscillation of the oscillator.

### PRIORITY CLAIM AND CROSS REFERENCE

This patent application is a U.S. National Phase of International Patent Application No. PCT/EP2024/053830, filed 15 Feb. 2024, which claims priority to German Patent Application No. 10 2023 202 302.4, filed 14 Mar. 2023, the disclosures of which are incorporated herein by reference in their entireties.

### SUMMARY

Illustrative embodiments relate to a transportation vehicle, to a user interface, and to a method of designing a graphical user interface of a transportation vehicle. In particular, illustrative embodiments relate to simple and ergonomic as well as entertaining customization of a graphical user interface with a screen (a matrix display).

### BRIEF DESCRIPTION OF THE DRAWINGS

Disclosed embodiments will be described in more detail below with reference to drawings, in which:

FIG. 1 shows a schematic illustration of an exemplary embodiment of a transportation vehicle in which a method is being performed;

FIG. 2 shows a view of a screen on which a tray for selecting an oscillator is presented;

FIG. 3 shows an exemplary embodiment of a user interface in which an oscillator oscillates in the Y direction;

FIG. 4 shows an exemplary embodiment of a user interface with a graphical user surface as an instrument cluster, within which a virtual oscillator interacts with a virtual analogous needle of a speedometer;

FIG. 5 shows a user interface on which are illustrated areas which are prohibited for the placement of an oscillator; and

FIG. 6 shows a flow diagram illustrating operations of an exemplary embodiment of a method of designing a graphical user interface.

### DETAILED DESCRIPTION

Conventionally, transportation vehicle are provided with a larger and larger display area in their interior. A wide range of configurations, ergonomic adaptations, and functional enhancements can be made by the users. For example, so-called home screens or tiles included therein can be moved or can be filled with different ranges of functions or different display ranges, or color schemes can be selected for the displays.

However, the options known in the prior art have not exploited all the technical possibilities. In particular, it is not possible for customization which can be clearly identified as such to be carried out readily. In particular, a user/an occupant of a transportation vehicle cannot be assisted by the infotainment system in such an operation.

DE 10 2018 216 409 A1 describes a method, a device, and a transportation vehicle. In a first operation, a position and/or acceleration of a transportation vehicle is identified. Depending on the position and/or the acceleration of the transportation vehicle and optionally on the identity of the occupant, the line of vision of the occupant, the presence of an occupant on a seat, the activity of an occupant, and an input of the occupant, in a second operation a sequence of moving images is generated which realistically represents a virtual liquid. Depending on the identity of the occupant, the line of vision of the occupant, the presence of an occupant on a seat, the activity of an occupant, and an input of the occupant, the sequence of moving images is displayed in a third operation on one or more displays of the transportation vehicle.

DE 10 2012 009 024 A1 discloses a display device of a transportation vehicle which consists of no more than three different graphical elements. The first element is a line which, analogously to an electrocardiogram, displays the readiness of the transportation vehicle to move away by a representation or illustration of an oscillation parameter, with a variable frequency and amplitude, but with no actual, virtual, or graphical oscillation. The second element represents a three-dimensional object which changes, for example, lengthens or bends, depending on the movement state of the transportation vehicle, for example, a speed, acceleration, or a steering angle of the steering wheel. The third element is the representation of the ground shown virtually in grid form which moves analogously with the actual movement state of the transportation vehicle, for example, a speed or an acceleration.

Starting from the abovementioned prior art, the presently disclosed embodiments mitigates or overcomes the abovementioned disadvantages of the conventional art.

The method serves to design a graphical user interface which comprises a matrix display (for example, a freely programmable instrument cluster, a central information display, a central display operating unit, or the like). These abovementioned elements are integrated into the graphical user interface of the transportation vehicle or are provided by hardware to provide the graphical user interface. The transportation vehicle can be configured as a passenger vehicle, delivery truck, motorcycle, goods vehicle, aircraft and/or watercraft. In a first operation, a virtually oscillatable element, which is also referred to below as an “oscillator”, is presented on a user interface. The user interface can thus visualize the oscillator by the matrix pixels. This operation can take place in a configuration mode for the graphical user interface. In particular, the presentation operation can already be performed during the configuration mode. In a second operation, a user input is detected or identified which represents a target position on the graphical user interface. In other words, the user specifies by the user input the position at which the oscillator is to be “virtually” attached in future. For example, to do this the user can, in the configuration mode, tap the target position or finish a swiping gesture at the desired target position. In response thereto, the oscillator can be placed at the target position.

Depending on the user input or the user gesture for defining the target position, the oscillator can “fly” or “migrate” from the starting position to the target position. In other words, the oscillator can move to the target position in a curve raised virtually above the surface of the graphical user interface or in virtual contact with the graphical user interface. The target position can be fixed, for example, by the user lifting their finger from the graphical user interface, in response to which, on the one hand, the oscillator is arranged at the target position and, on the other hand, the configuration mode is optionally automatically exited and the other elements of the graphical user interface can be operated again and/or appear in a display and/or operating mode. For example, during the configuration mode the graphical user interface can be largely blurred or superimposed by a drawer, a view, or a window (referred to below as a “tray”) which includes the oscillator and/or a large number of (possibly different) oscillators. This tray can in principle also be presented on a smart device, a mobile device, a wearable user end device, or the like. The only important thing is that the oscillator can be selected assignably and the target position can be defined sufficiently precisely such that the oscillator from the tray (wherever it is arranged) can be positioned in the graphical user interface of the transportation vehicle.

In a next operation, a signal representing an acceleration and/or a vibration of the transportation vehicle is identified. This can be effected, for example, by acceleration sensors or the transportation vehicle. Alternatively or additionally, acceleration sensors loaded onto a smart device of the user can be used. In response to the receipt of the signal and depending on the nature/characteristics of the signal, oscillation of the oscillator is animated. The oscillator itself provides a predefined virtual physical property which can be defined, for example, by a pendulum length, a restoring force, or other physical parameters. For example, it is also possible for the virtual piece of string by which the oscillator is fastened on the graphical user surface to be configured as elastic and/or with/without mass. By activating the oscillator by the signal, the user can receive feedback about the movement state of the transportation vehicle, as a result of which travel sickness can be prevented. The user can freely configure both the oscillator and its position such that a particularly user-friendly and esthetic presentation results which corresponds to the user's wishes.

Compared with arrangements known in the prior art for customizing a screen of a user interface of a transportation vehicle, the oscillator can be clearly identified as content lying outside the function of the remainder of the user interface. In particular, the oscillator has no operating function which affects the triggering of a transportation vehicle function or a transportation vehicle actuator. Instead, the oscillator is an essentially passive element which, apart from avoiding travel sickness, can be designed and referred to as a retro customization element. It can in this way be avoided that in the event of a crash oscillators actually arranged as hardware in the transportation vehicle to avoid travel sickness might constitute a safety hazard or irreversible damage might be caused to the fastening of the oscillator to the interior of the transportation vehicle.

The user can optionally start the abovementioned customization by a configuration mode being explicitly initiated. In other words, the user can start the abovementioned tray by performing a predefined gesture, by calling up the configuration mode by a voice command and/or by their smart device, or otherwise. In a second operation, the tray is presented on a screen and an accepted user input (selection gesture) with respect to an oscillator presented in the tray is identified. In other words, the user's wish to remove a desired oscillator from the tray is identified by sensors. For example, to do this the user can make a tapping gesture on the oscillator or start a swiping gesture on the oscillator. The removed oscillator can then, as described above, be moved to its target position.

The removal of the oscillator from the tray may be optionally acknowledged optically and/or acoustically by a change in position of the oscillator relative to the tray and/or an optical enlargement of the oscillator and/or an enlargement of the distance of a virtual shadow of the oscillator from the oscillator itself and/or an oscillation and/or rotation/inclining of the oscillator and/or playing an animation with respect to the oscillator taking place. In this way, feedback can be given to the user as to which oscillator has been selected and prepared for placement at a target position.

In particular, the removal of the oscillator, and optionally already the calling-up of the configuration mode, can be accompanied by the graphical user interface of the transportation vehicle being made unresponsive to other inputs. In other words, user inputs cannot be made at certain positions until the oscillator has been successfully placed and/or until the customization process is interrupted to avoid undesired inputs of the user. This situation can be illustrated, for example, by blurring the user interface or “greying out”. This process can also be accompanied by a sound notification.

The configuration mode can optionally (automatically) be exited after the selected oscillator has reached its target position. Alternatively, the configuration mode can be exited by the user giving explicit orders to close the tray. For example, to do this the tray can be removed from the display surface by a swiping gesture and/or a button (X) provided specifically for this purpose.

In particular when the tray is presented on the display surface which is to be customized by the selected oscillator, it can be beneficial, once an oscillator has been successfully selected, to (temporarily) hide the tray so as not to cover with the tray the position at which the oscillator might be placed. In this case, immediately after the oscillator has been placed at the target position, the tray can be unhidden again or a new explicit call-up gesture for presenting the tray can be required.

In order to optically acknowledge the placement of the oscillator at the target position, optical reduction in the size of the oscillator and/or increasing the distance away of a virtual shadow of the oscillator and/or (possibly renewed) rotation/inclining of the oscillator and/or playing an animation with respect to the oscillator can take place here. In this way, intuitively understandable feedback is given to the user that the oscillator is now present at the target position until a separate action to remove it is carried out.

In order to prevent important information which is presented on the graphical user interface from inadvertently being covered by the oscillator, so-called no-go areas or “prohibited areas” on the graphical user interface can be predefined and/or be predefined by the user at which the oscillator cannot be placed. The same is true for operating elements/buttons etc which are also to be usable or visible after placement of the oscillator so as not to design the user interface impractically. For this purpose, the user can be prohibited from selecting the target position inside a no-go area or from using a selected target position within a prohibited area to place the oscillator. Instead, the oscillator can be automatically pulled back into the tray when the user wishes to make the placement in the prohibited area. Alternatively, the oscillator can be automatically placed immediately next to the currently selected prohibited area as if it has been slid out of the area. In order to inform the user in good time about the positions at which they can place the oscillator and those where they cannot, a graphical visualization of the prohibited areas and/or the allowed areas can be effected (for example, after selecting the oscillator). The user can then ensure that its target position lies outside a prohibited area.

Optionally, the user can change the size of the selected oscillator at their own discretion. For example, to do this they can perform a two-finger gesture (pinch or spread) during the placement of the oscillator or afterward such that they can so to speak make a gradual change to the size and/or rotational position of the oscillator.

Optionally, the user can exit the configuration mode by tapping a position next to the tray (where present) and next to the oscillator.

The oscillator can, for example, be moved to a new position by a long press gesture being carried out with respect to the oscillator or its anchor point. The oscillator can here perform one of the abovementioned animations or accept optical changes which have been described in connection with the acceptance/removal from the tray. An X button can here also be presented in the region of the oscillator and, when it is actuated, the oscillator is removed or arranged again in the tray. When detaching the oscillator by a long press gesture, the user can define a changed target position for the oscillator by a tapping gesture at a new target position and/or by performing a swiping gesture. The detaching can also be accompanied by a sound notification.

The identification of the user input (removal of the oscillator, definition of the target position etc.) can be made, for example, by a touch-sensitive surface of a touch screen. In particular, the screen which is to be customized by the oscillator can itself have this touch-sensitive surface (digitizer). Alternatively or additionally, a camera can identify a gesture of the user. A 3D gesture can also be identified by a camera in such a way that the selection of the oscillator is identified by a first tapping gesture (in contact with the surface or freely in space), a movement of the hand in the region in front of the graphical user interface (without contact with the user interface) entails an immediate shifting of the oscillator to a projection position of the hand, and tapping again at the target position (in contact with the surface or freely in space) is identified by the camera. A different optical sensor (for example, an infrared sensor) can also be used instead of a camera to capture the 3D gesture of the user.

Further optional features and examples with respect to the presently disclosed embodiments are given below with no limiting character in terms of the scope of protection.

When mention is made of removing or positioning the oscillator, both a centroid of the oscillator itself or a suspension point can here be manipulated or grabbed and moved by the user. The same is true for the target position, which is made congruent by the user's gesture with the oscillator itself or the suspension point thereof.

Depending on the type or nature of the oscillator, its interaction with the rest of the graphical user surface or the remainder of the interior of the transportation vehicle can also be designed. If, for example, a mirror ball is used as an oscillator, the mirror ball can be illuminated virtually and thus cause reflections on the graphical user surface. They can naturally oscillate with the mirror ball when it moves. In addition, further lighting elements can be used in the interior of the transportation vehicle to reproduce or extend the optical effect of the mirror ball. For example, ambient lighting of the transportation vehicle can be activated in such a way that reflections or moving light patterns which match the movements of the mirror ball or the light hitting the mirror ball are simulated. In particular, individually activatable lamps of an ambient lighting system as an LED script can cause light and dark spots of light to decorate the dashboard and/or the interior door trim. This light pattern can depend on a position and/or orientation and/or direction of rotation and/or rotational speed of the oscillator or the mirror ball. For example, for this purpose, individual lamps of the ambient lighting can be switched off at regular intervals.

A series of known analogs from the real world can be considered as examples of possible optical and virtual mechanical configurations of the oscillator. For example, a tree air freshener as a (green) Christmas tree can be used as the oscillator which is usually placed on an interior rearview mirror of the transportation vehicle. Depending on the equipment of the transportation vehicle, an interaction with the tree air freshener can also scent the interior air (possibly with a corresponding fragrance). Another example for an oscillator is a mirror ball which can oscillate and in particular rotate about itself. As a result, there are many options for optically reproducing the light pattern of the mirror ball, as has been described above. Alternatively, a miniature child's shoe or pair of child's shoes can be used as a pendulum. A fox's tail or a pair of dice can also be selected as a virtual oscillator. In particular, predefined sound notifications can be associated with each oscillator which are played in the case of a movement per se or a collision with the transporation vehicle interior surface (in particular the display surface or the molding surrounding the display) and includes the user in the oscillating retro experience. A further example of an oscillator is constituted by a so-called nodding dog or a so-called dancing Elvis. These are usually fixed in their base region and, when force acts on them, tend to oscillate in an upper region (upper body or head). Examples of acoustic sound notifications are constituted by musical sequences, howling, or barking.

A change in length of the oscillator and thus also a change in its natural frequency can be made, for example, by performing a two-finger gesture (performed in contact with the user surface or freely in space). For example, to do this the user can grab/touch the anchor point of the oscillator with one finger and the oscillator itself with the second finger and then move the fingers toward each other to reduce the size of the oscillator/pendulum, and move the fingers apart from each other to increase the size of the oscillator/pendulum. This can take place already in the tray and/or after the oscillator has been positioned. The size can of course also be changed in the course of a movement of the oscillator from the tray to its target position.

The oscillator can in particular then stimulate/satisfy the user's instinct for playfulness by it being caused to oscillate by user interaction. In other words, the oscillator placed at the target location can be tapped or nudged to oscillate in a predefined direction. A direction of oscillation parallel to the surface of the graphical user surface can be effected, for example, by a swiping gesture which sweeps over the oscillator and/or its string. The oscillator itself can also be grabbed and lifted up or deflected by a swiping gesture then to perform a free oscillation after the oscillator has been let go.

If the oscillator is to be removed, a user interaction with respect to the oscillator, in particular a long press gesture, can be performed to detach the oscillator and, for example, to move it back into the tray. Alternatively, after the long press gesture, an X button can be displayed in the region of the oscillator and in response to the actuation of which the oscillator is removed from the graphical user surface.

The oscillator is particularly realistic or entertaining when it interacts with objects presented within the graphical user surface. For example, it can be nudged, deflected, and/or set in rotation by an ego position of a transportation vehicle or other elements in a map display, a needle of an analogous or virtually analogous display instrument (speedometer, tachometer, or the like). A virtual tape deck can also be pivoted open to load a new recording. The pivoting open of the tape desk can then interact with the oscillator in such a way that the latter starts to oscillate.

The oscillations of the oscillator can have different direction components. Braking and acceleration can cause the oscillator to oscillate in an X direction of the transportation vehicle. Steering movements can cause the oscillator to oscillate in a Y direction. In particular, lifting the oscillator with a user's finger or pulling the oscillator down by the user's finger can, when the oscillator is “elastically suspended”, cause the oscillator to dance in the Z direction. Some or all of the abovementioned directions of oscillation can of course be superposed. A tank level indicator, an analogously designed drive position indicator, an analogous clock, or the like can be virtually presented on the display device and interact virtually with the virtual oscillator. In this way, the oscillator acts particularly realistically and offers a high level of entertainment.

If the oscillator collides with a surface of the transportation vehicle interior, it can be detected by a sensor (for example, a touch-sensitive surface and/or camera and/or infrared sensor or the like) and be acknowledged by an oscillator-specific sound notification. In particular, the interior surface with which the oscillator collides can also (partly) define the sound notification.

According to a second aspect of utility, a user interface for defining a graphical user interface of a transportation vehicle is proposed. In other words, the graphical user interface can be customized for a transportation vehicle according to the abovementioned method. To do this, the user interface has an evaluation unit with a data input and a data output. The user interface is configured by the data output to present a virtually oscillatable element (oscillator) on a display device of the user interface in a configuration mode. The presentation can be effected as described above already during the selection of an oscillator or after it. By the data input, the user interface can identify a user input representing a target position on the user interface, and in response thereto place an oscillator at the target position by the data output. The user interface is thus also configured to correspondingly implement the features, combinations of features, and the benefits resulting therefrom of the method clearly in such a way that reference should be made to the above explanations to avoid repetitions.

According to a third aspect of utility, a transportation vehicle with a user interface according to the second-mentioned aspect is provided. The transportation vehicle can be configured as a passenger vehicle, delivery truck, goods vehicle, motorcycle, aircraft and/or watercraft. In this way, the same features, combinations of features, and benefits as described above also result for the transportation vehicle.

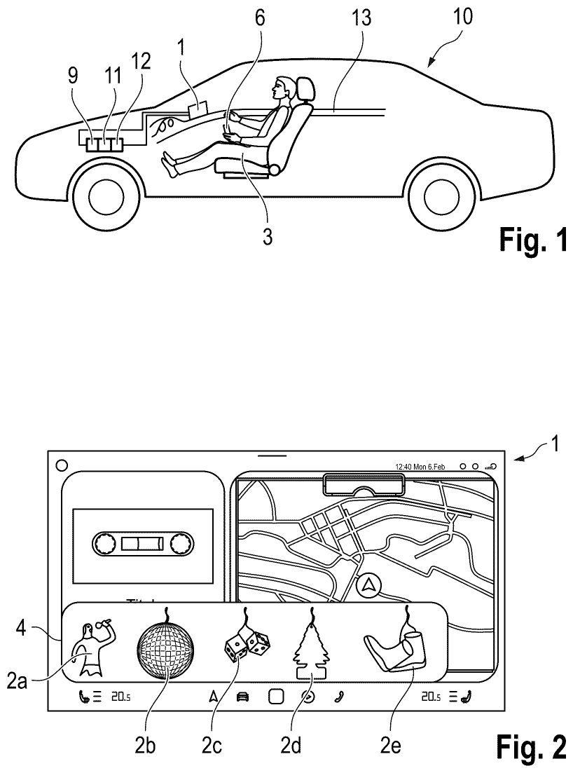

FIG. 1 shows a schematic illustration of an exemplary embodiment of a transportation 10 as a passenger vehicle, the user 3 of which is carrying a smartphone 6 by which they wish to customize a graphical user interface 1 as a central information display. The smartphone 6 is connected wirelessly to an evaluation unit 11 as a control device. The evaluation unit 11 has a data input 9 and a data output 12. Both the data input 9 and the data output 12 are connected to the user interface 1 via cables using information technology. By selecting an oscillator, presented on the smartphone 6, in a virtual tray, the user 3 can perform a pointing gesture by which they implement a target position for placing the oscillator on the user interface 1.

The transportation vehicle 10 furthermore has an ambient lighting system 13, the lamps of which can be activated individually to reproduce reflections of the oscillator.

FIG. 2 shows an alternative exemplary embodiment of a graphical user interface 1 on which a semi-transparent tray 4 as a foreground window is presented. The tray 4 has a large number of oscillators 2a to 2e. The remaining areas outside the tray 4 are blurred. A dancing Elvis, a mirror ball, a pair of dice, a tree air freshener, and a pair of child's shoes can be selected within the tray 4 as oscillators 2a to 2e. For example, a user can tap on a desired example, in response to which the tray disappears, and then tap on a desired position as a target position on the graphical user surface 1, in response to which the example of the oscillator is arranged at the relevant location. It can here be predefined or configured by the user whether the target position is assigned to the centroid of the pendulum/oscillator or to the anchor point. It should be mentioned in this connection that in particular the anchor point does not necessarily have to be located within the graphical user surface 1 and instead the centroid of the selected oscillator can be placed at the target position, whereas the suspension/anchor point can be situated above the upper edge of the graphical user surface 1.

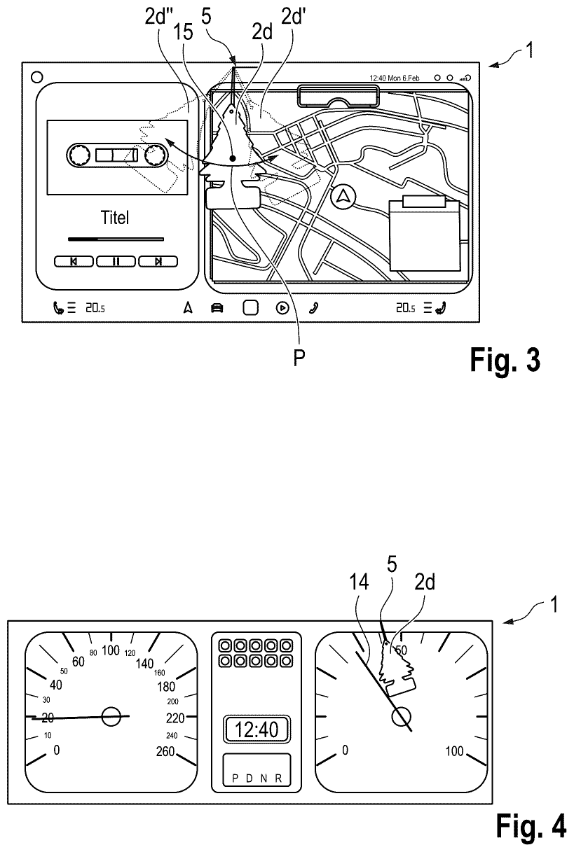

FIG. 3 shows an exemplary embodiment of a user interface with a graphical user surface 1 after the selection of the tree air freshener 2d and the fastening thereof in the central area of the upper edge of the graphical user surface 1. By monitoring the steering movements and/or the driving speed and/or signals of an acceleration sensor of the transportation vehicle, a transverse acceleration (acceleration in the Y direction) is identified. In response thereto, the tree air freshener 2d is animated so that it oscillates back and forth, as illustrated by a double-headed arrow D, between a first extreme position 2d′ and 2d″. The position of the shadow 16 of the tree air freshener 2d can, in the case of oscillation in the X direction of the transportation vehicle, vary (into and out of the plane of the drawing) in its distance from the tree air freshener 2d itself or from its centroid 15 to represent a virtual distance from the surface of the map display.

FIG. 4 shows an exemplary embodiment of a user interface with a graphical user surface 1 as a retro instrument cluster which is displayed as a matrix display. The analogously manifesting instruments, a speedometer and a tachometer, have analogous needles 14. The user has arranged a tree air freshener 2d in the region of the tachometer at an anchor point 5 in the region of the upper edge of the graphical user surface 1. The tree air freshener 2d thus hangs in the active area of the needle 14 of the tachometer. If the needle 14 collides with the tree air freshener 2d, the needle 14 can deflect the tree air freshener 2d from a rest position and, in the case of a predefined deflection being exceeded and/or in the case of a superposed predefined vibration, the tree air freshener 2d can start to oscillate freely or can collide again with the needle 14. The same is true for the drive position indicator presented or the speedometer.

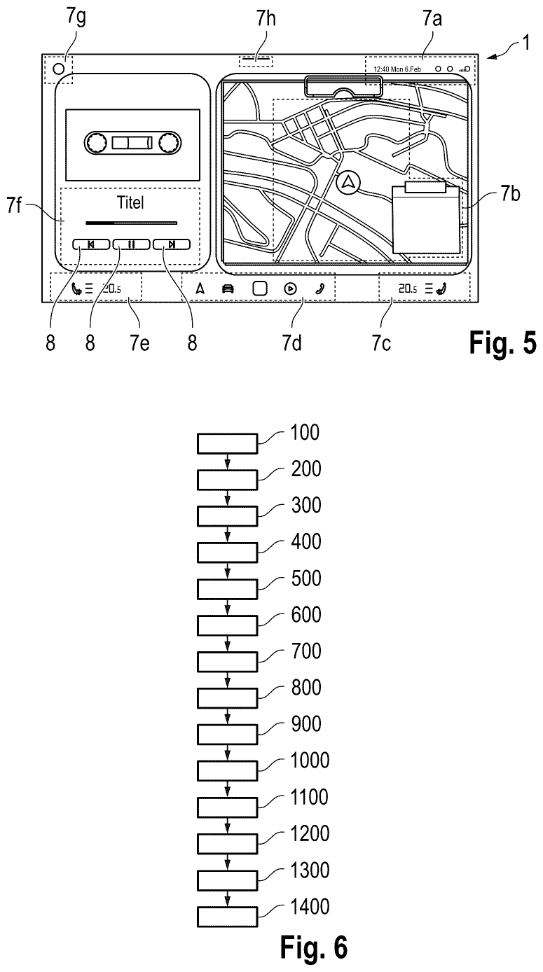

FIG. 5 shows prohibited areas 7a to 7h on an exemplary embodiment of a graphical user interface 1, according to FIG. 3, which can be used according to the disclosed embodiments. For example, operating elements 8, areas of a digital road map in the region of the ego position of the ego transportation, and other important display elements in the region of the header and the footer are protected by the prohibited areas 7a to 7h from being covered by a virtual oscillator.

FIG. 6 shows a flow diagram illustrating operations of an exemplary embodiment of a method for outputting feedback to an occupant about a driving state of a transportation vehicle by a graphical user surface. In a first operation 100, a configuration mode is started by the user opening a tray inside which a selection of different examples of virtual oscillators are stored. In response thereto, the large number of different oscillators inside the tray are presented in operation 200. In operation 300, a predefined accepted user gesture with respect to an oscillator, presented in the tray, of the large number of oscillators is identified. The accepted user input can include, for example, a tapping gesture and/or a swiping gesture. In response to the identification of the accepted user gesture, in operation 400 the oscillator is animated as a response to the user to the accepted user input. In operation 500, the oscillator from the tray is moved in the direction of a target position. The oscillator is here presented continuously but its virtual distance from the graphical user surface can vary. This is in particular the case when the user gesture comprises a 3D gesture performed freely in space. The impression can be further strengthened by increasing the distance between the oscillator and the shadow it casts, enlarging the oscillator, changing the virtual light conditions in which the oscillator appears, etc. In operation 600, a user input with respect to the oscillator is identified and, in response thereto, in operation 700 a check is made that a target position which the user indicates is predefined as allowed for placement of the oscillator.

Because the selected target position is allowed, in operation 800 the oscillator is placed at the target position on the graphical user surface 1. The oscillator is now placed and the graphical user surface automatically reverts from the configuration mode to a display and/or operating mode. Whilst the user is driving or because of other events, in operation 900 a signal representing an acceleration and/or a vibration and/or a deflection of the transportation vehicle is then identified, and in response thereto and depending on a nature/size of the signal, an oscillation of the oscillator is animated in operation 1000. The identification of the acceleration/deflection/vibration of the transportation can be effected by sensors. Hardware of the transportation vehicle or of a portable user device carried by the user can be used for this purpose. In operation 1100, because of high amplitudes of the oscillator, a virtual collision of the latter with a surface of the transportation vehicle interior is detected. In response thereto, in operation 1200 a mechanical reaction of the oscillator to the collision is simulated. For example, the oscillator can bounce off the surface or be deflected by the surface. Alternatively or additionally, a moving surface (needle, controller, or the like) can deflect the virtual oscillator.

A sound notification can here also be output as an acoustic response to the collision. In operation 1300, a user interaction (tapping or nudging) with respect to the placed oscillator is identified. For example, the user can tap on the graphical user surface in the region of the oscillator to provoke a reaction of the oscillator. In response thereto, an oscillation of the oscillator is animated or, when a long press gesture is performed, in operation 1400 the oscillator is detached from the target position. In other words, in operation 1400 the oscillator or the graphical user surface is restored to the configuration mode in which the user replaces the oscillator in the tray or, by tapping on an X button which is then presented, can remove the oscillator from the surface.

### LIST OF REFERENCE SIGNS

1 graphical user surface
2 to 2e oscillator
3 user
4 tray
5 anchor point
6 smartphone
7a to 7h prohibited area
8 operating element
9 data input
10 transportation vehicle
11 evaluation unit
12 data output
13 ambient lighting
14 needle
15 centroid
16 shadow
100 to 1400 method operations

1. A method for outputting feedback to an occupant about a driving state of a transportation vehicle by a graphical user surface, the method comprising:
presenting a virtually oscillatable oscillator on the user surface,
determining a user input with respect to the oscillator, and in response to the determined user input, placing the oscillator at a target position on the graphical user surface, determining a signal representing an acceleration and/or a vibration, and in response to the determined signal and depending on the signal animating an oscillation of the oscillator.

2. The methodof claim 1, further comprising starting a configuration mode, presenting a plurality of different oscillators in a view and/or a window and/or a virtual drawer tray, determining a predefined accepted user input with respect to an oscillator of the plurality of oscillators presented in the tray, and in response thereto animating the oscillator presented in the tray in response to the accepted user input.

3. The method of claim 2, wherein the animating comprises:
a change in position of the oscillator relative to the tray, and/or
an optical enlargement of the oscillator, and/or
an enlargement of a distance of a virtual shadow of the oscillator from the oscillator itself, and/or
a rotation of the oscillator, and/or
playing an animation with respect to the oscillator.

4. The method of claim 3, further comprising:
determining a position and/or orientation and/or direction of rotation and/or rotational speed of the oscillator, and depending thereon,
specifying a light pattern of an ambient lighting system of the means of transportation vehicle.

5. The method of claim 1, wherein the oscillator has the appearance of a tree air freshener or a mirror ball or a child's shoe or a fox's tail or a pair of dice or a nodding dog or a dancing Elvis, and/or the oscillator projects virtual light reflections onto the surrounding user surface.

6. The method of claim 1, further comprising:
checking the target position as to whether it is predefined as allowed or not allowed for placement of the oscillator, and
placing the oscillator at the target position or not based on a result of the check.

7. The method of claim 1, wherein the user input representing the target position comprises a tapping gesture and/or an end position of a swiping gesture, wherein the target position defines an anchor position for the oscillator or a centroid of the oscillator.

8. The method of claim 1, further comprising:
determining a user interaction with respect to the placed oscillator, and in response thereto, animating an oscillation of the oscillator or moving the oscillator away from the target position.

9. The method of claim 1, further comprising determining a virtual collision between the oscillator and a display element, and in response thereto, simulating a mechanical reaction of the oscillator to the collision.

10. The method of claim 2, wherein, in the configuration mode, no user gestures are permitted with respect to other elements of the user surface.

11. The method of claim 1, further comprising determining a virtual oscillatory movement with a predefined amplitude in an x or y direction of the transportation vehicle, and in response thereto, outputting a sound notification to provided the predefined amplitude is reached by the oscillator.

12. The method of claim 1, wherein the user input is identified by a touch-sensitive surface and/or a camera and/or an infrared sensor.

13. The method of claim 1, wherein the display comprises an instrument cluster and/or a central display control device.

14. A user interface for configuring a graphical user surface of a transportation vehicle, the user interface comprising:
a data input,
a data output, and
an evaluation unit,
wherein the user interface is configured to;
present, by the data output, a virtually oscillatable oscillator on the graphical user surface in a configuration mode,
identify by the data input a user input representing a target position on the user surface, and in response thereto,
place the oscillator at the target position by means of the data output,
identify, by the data input, a signal representing an acceleration and/or vibration, and in response thereto and depending on the signal, and
animate, by the data input, an oscillation of the oscillator.

15. The user interface as claimed in of claim 14, which is configured to start a configuration mode, present a plurality of different oscillators in a view and/or a window and/or a virtual drawer tray, determine a predefined accepted user input with respect to an oscillator of the plurality of oscillators presented in the tray, and in response thereto animate the oscillator presented in the tray in response to the accepted user input.

16. A transportation vehicle comprising a user interface of claim 14.

17. The user interface of claim 14, wherein the animation comprises:
a change in position of the oscillator relative to the tray, and/or
an optical enlargement of the oscillator, and/or
an enlargement of a distance of a virtual shadow of the oscillator from the oscillator itself, and/or
a rotation of the oscillator, and/or
playing an animation with respect to the oscillator.

18. The user interface of claim 17, wherein the user interface is configured to determine a position and/or orientation and/or direction of rotation and/or rotational speed of the oscillator, and depending thereon, specify a light pattern of an ambient lighting system of the transportation vehicle.

19. The user interface of claim 14, wherein the oscillator has the appearance of a tree air freshener or a mirror ball or a child's shoe or a fox's tail or a pair of dice or a nodding dog or a dancing Elvis, and/or the oscillator projects virtual light reflections onto the surrounding user surface.

20. The user interface of claim 14, wherein the user interface is configured to check the target position as to whether it is predefined as allowed or not allowed for placement of the oscillator, and place the oscillator at the target position or not based on a result of the check.
